(19) United States
(12) Patent Application Publication
(10) Pub. No.: US 2008/0240331 A1
(43) Pub. Date: Oct. 2, 2008

(54) INSPECTION APPARATUS FOR REACTOR BOTTOM MOUNTED INSTRUMENTATION NOZZLE

(76) Inventors: Min-Su PARK, Seongnam-Si (KR); Sang-Hoon Choi, Yongin-Si (KR); Eui-Soon Doh, Gyeongju-Si (KR); Nag-Jeam Kim, Yongin-Si (KR); Dong-Il Kim, Yongin-Si (KR); Yoon-Won Kim, Busan-Si (KR)

Correspondence Address: BIRCH STEWART KOLASCH & BIRCH, PO BOX 747, FALLS CHURCH, VA, 22040-0747, US

(21) Appl. No.: 11/852,124

(22) Filed: Sep. 7, 2007

(30) Foreign Application Priority Data
Dec. 14, 2006 (KR) 20-2006-0031730

(51) Int. Cl. G21C 17/00

(52) U.S. Cl. 376/249

(57) ABSTRACT

Provided is an inspection apparatus for a reactor BMI nozzle. The apparatus includes a motor, a ball screw, a guide, and a coil spring. The motor is installed at a transmission of a bracket provided under a quick connector of an ROSA-V six-axis system and enables vertical driving of an inspection probe. The ball screw converts a rotary motion of the motor into a vertical motion and vertically reciprocating the inspection probe. The guide compels an axial arrangement of the inspection probe and removes eccentricity generated when the inspection probe is inserted into the nozzle. The coil spring is installed above the guide and prevents an impact propagation of an instrument.

This Nonprovisional application claims priority under 35 U.S.C. § 119(a) on Utility Model Application No. 20-2006-0031730 filed in Korea on Dec. 14, 2006, the entire contents of which are hereby incorporated by reference.

### BACKGROUND OF THE INVENTION

1. Field of the Invention

The present invention relates to an automatic inspection apparatus for a reactor Bottom Mounted Instrumentation (BMI) nozzle, and more particularly, to an automatic inspection apparatus for a reactor BMI nozzle, installed at a Remotely Operated Service Arm-V (ROSA-V) six-axis system and automatically performing a defect inspection for a weld part of the reactor BMI nozzle or a fine crack defect inspection for a vessel nuclear reactor.

2. Description of the Background Art

In general, many instruments are installed around a nuclear reactor 1. As shown in FIG. 1, key instruments are a steam generator 2, a cooling pump 3, and a pressurizer 4 around the nuclear reactor 1. The instruments each are connected using high-pressure pipes 3-5.

Key functions of the instruments have been already known and recognized by those skilled in the art. A detailed description of the functions will be omitted.

When the nuclear reactor 1 operates for a long time at high pressure and high temperature, its interior suffers a great stress. Thus, a weld part or a vessel of the nuclear reactor suffers from fine cracks or defects because of a fatigue. Resultantly, the fine cracks or defects bring about a fatal result and lead to a leakage of light water within the reactor.

Nondestructive inspection is generally performed to prevent and remove the fine cracks or defects generated within the nuclear reactor.

Thus, a nondestructive inspection for a head part of the reactor is performed using a conventional equipment “DERI” or “ROHIS”. A nondestructive inspection for weld parts of inlet and outlet pipes of the reactor and a weld part within the vessel of the nuclear reactor is performed using an equipment “SUPREEM”.

As above, most of the weld parts of the reactor are being inspected by periods. However, the real circumstances are that in the case of a reactor BMI nozzle, a weld part and a vessel of nuclear reactor have not yet been inspected at all because an equipment is limited in development and size.

### SUMMARY OF THE INVENTION

Accordingly, the present invention is to solve at least the problems and disadvantages of the background art.

The present invention is to provide an automatic inspection apparatus for a reactor BMI nozzle, installed at a Remotely Operated Service Arm-V (ROSA-V) six-axis system and automatically performing a defect inspection for a weld part of the reactor BMI nozzle or a fine crack defect inspection for a reactor vessel.

To achieve these and other advantages and in accordance with the purpose of the present invention, as embodied and broadly described, there is provided an inspection apparatus installed at a quick connector of an ROSA-V six-axis system and automatically inspecting a reactor BMI nozzle. The apparatus includes a motor, a ball screw, a guide, and a coil spring. The motor is installed at a transmission of a bracket provided under the quick connector of the ROSA-V six-axis system and enables vertical driving of an inspection probe. The ball screw converts a rotary motion of the motor into a vertical motion and vertically reciprocating the inspection probe. The guide compels an axial arrangement of the inspection probe and removes eccentricity generated when the inspection probe is inserted into the nozzle. The coil spring is installed above the guide and prevents an impact propagation of an instrument.

The apparatus may further include two universal joints installed over the inspection probe and reducing a rotary resistance caused by eccentricity when the inspection probe is inserted into the nozzle and performs rotary scanning.

The apparatus may further include a bladder installed under the motor and preventing the ROSA-V from hanging down due to a self-weight of an end effector.

The apparatus may further include a cross shape guide installed at a lower end of the ball screw and guiding four-direction motion of the inspection probe.

### BRIEF DESCRIPTION OF THE DRAWINGS

The invention will be described in detail with reference to the following drawings in which like numerals refer to like elements.

FIG. 1 is a diagram illustrating a main system around a nuclear reactor;

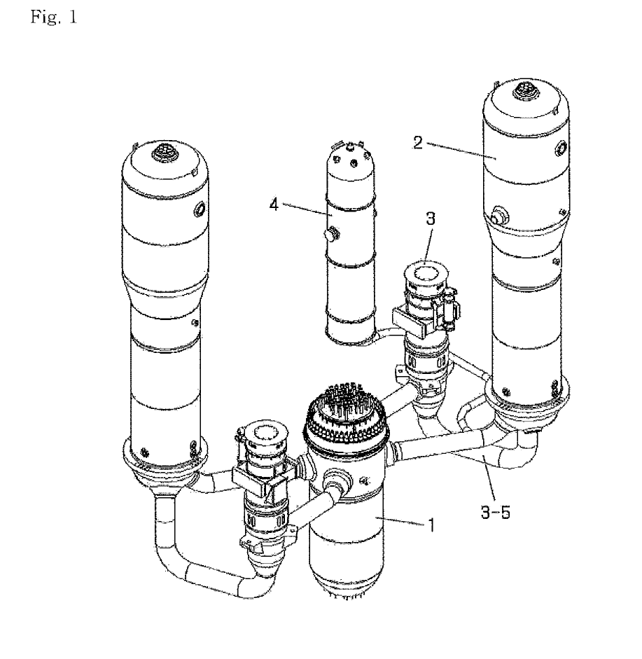

FIG. 2 is a partial cut-away perspective diagram illustrating a nuclear reactor equipped with a nozzle inspection apparatus according to the present invention;

FIG. 3 is a perspective diagram illustrating an ROSA-V of a nuclear reactor and a nozzle inspection apparatus installed at the ROSA-V according to the present invention;

FIG. 4 is a detailed diagram illustrating an inspection apparatus for a reactor BMI nozzle according to the present invention; and

FIG. 5 is a diagram illustrating an inspection apparatus for a reactor BMI nozzle according to an exemplary embodiment of the present invention.

### DETAILED DESCRIPTION OF PREFERRED EMBODIMENTS

Preferred embodiments of the present invention will be described in a more detailed manner with reference to the drawings.

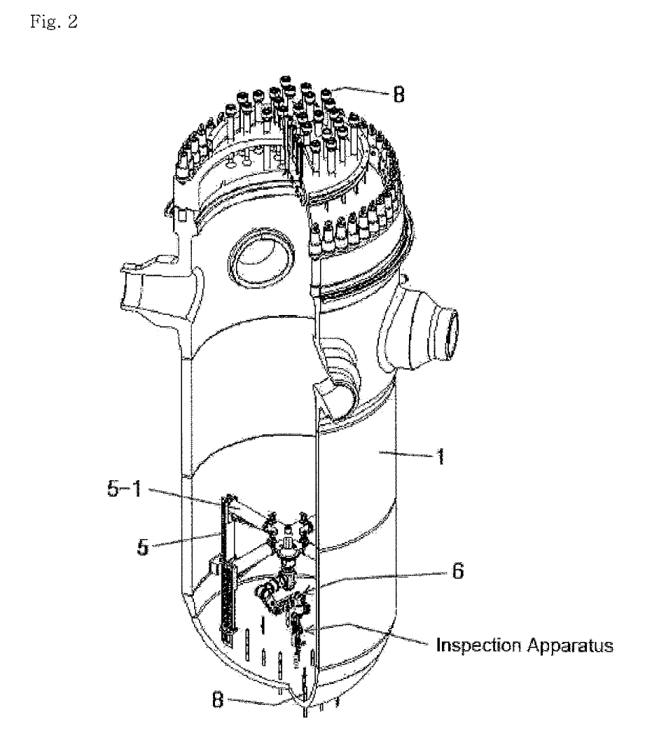

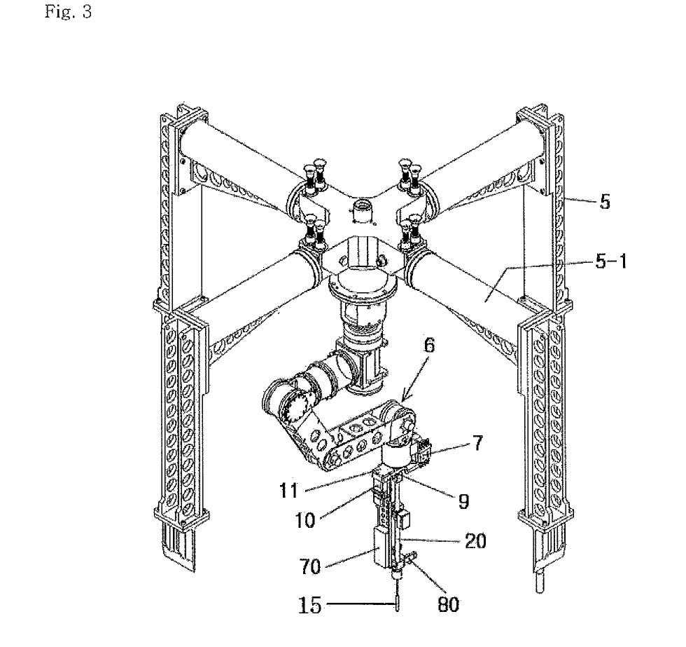

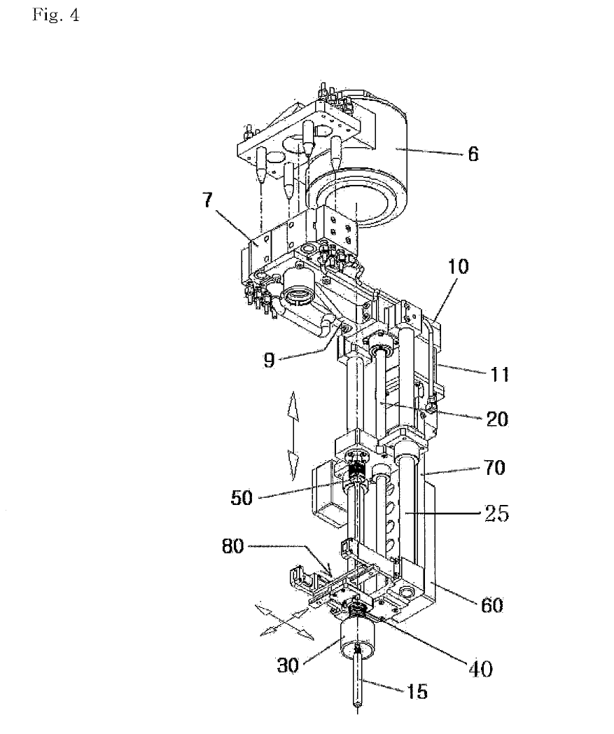

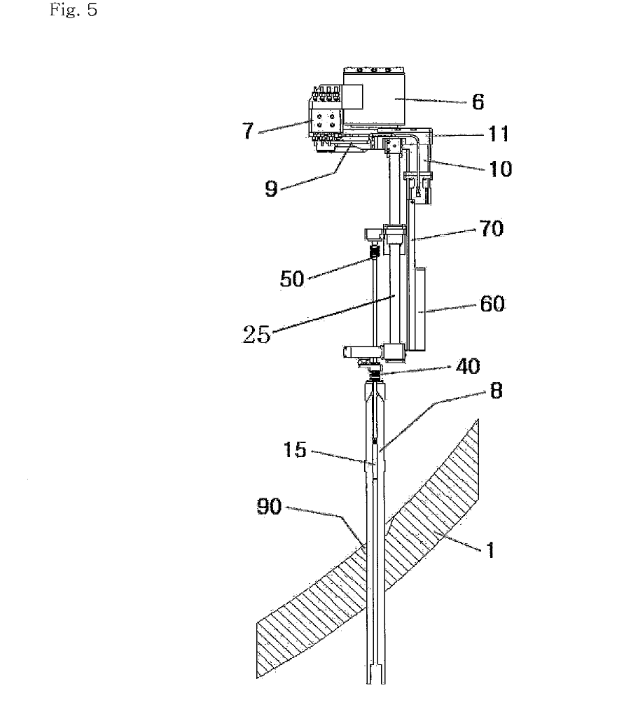

FIG. 2 is a partial cut-away perspective diagram illustrating a nuclear reactor equipped with a nozzle inspection apparatus according to the present invention. FIG. 3 is a perspective diagram illustrating an ROSA-V of a nuclear reactor and a nozzle inspection apparatus installed at the ROSA-V according to the present invention. FIG. 4 is a detailed diagram illustrating an inspection apparatus for a reactor BMI nozzle according to the present invention. FIG. 5 is a diagram illustrating an inspection apparatus for a reactor BMI nozzle according to an exemplary embodiment of the present invention.

A great stress to a vessel of the nuclear 1 reactor is generated within the nuclear reactor 1 because of high heat and pressure resulting from a nuclear reaction. Thus, the nuclear reactor 1 has a great firm structure and withstands the great stress.

The vessel of the nuclear 1 reactor is divided into a head part and a bottom part. Dozens of nozzles 8 are welded to the head part and the bottom part. As shown in FIG. 2, the nozzle inspection apparatus is installed using supports 5 provided at the bottom part of the nuclear reactor 1.

The support 5 is a structure equipped with a reactor interior nondestructive inspection device that is called “SUPRIM”. As shown in FIGS. 2 and 3, the three to four supports 5 each have three to four legs 5-1. The ROSA-V 6, an articulated robot, is mounted at the legs 501. The inspection apparatus is installed at an end part of the ROSA-V 6.

In other words, the interior of the reactor is inspected as being filled with water by a depth of about 2 meters to prevent a worker from suffering a radioactivity. The nuclear reactor 1 has dozens of nozzles 8 and each variety of weld parts 90 (FIG. 5) at its bottom. Inspection for the nozzles 8 and the weld parts 90 is performed using the ROSA-V 6. The nozzle inspection apparatus is installed at an end part of the ROSA-V 6.

The welding part 90 of the nozzle 8 has a structure of making the interior of the reactor airtight by welding. The nozzle 8 is designed differently in number depending on a size of the nuclear reactor 1.

Thus, the inspection apparatus installed at the ROSA-V 6 is made possible to freely move up/down and left/right.

The inspection apparatus for inspecting the reactor BMI nozzle 8 according to the present invention is installed at a quick connector 7 of the ROSA-V six axis system 6 installed within the reactor 1 and automatically inspects a state of a connection part of the nozzle 8 which is installed at a bottom of the reactor 1 to penetrate the interior of the reactor 1 and the nuclear reactor. As shown in FIG. 4, the inspection apparatus includes a motor 10, a ball screw 20, a guide 30, a coil spring 40, a universal joint 50, a bladder 60, and a cross shape guide 80 as main constituent elements.

The motor 10 is installed at a transmission 11 of a bracket 9 provided under the quick connector 7 of the ROSA-V six-axis system 6 and enables vertical driving of an inspection probe 15.

A rotary motion of the inspection apparatus is enabled by the ROSA-V six-axis system 6 because an end effector 70 is not equipped with a motor for enabling the rotary motion of the inspection apparatus.

The ball screw 20 is installed between two vertical guides 25 fixed to a bracket 9 and guiding a vertical motion of the inspection probe 15. The ball screw 20 converts a rotary motion of the motor 10 into a vertical motion.

The ball screw 20 vertically reciprocates the inspection probe 15 by converting the rotary motion of the motor 10 into the vertical motion.

The guide 30 compels an axial arrangement of the inspection probe 15 and removes eccentricity generated when the inspection probe 15 is inserted into the nozzle 8 to inspect the nozzle 8.

As shown in FIGS. 3 to 5, the guide 30 is provided in a funnel shape such that the inspection probe 15 can be easily arranged when inspecting the nozzle 8.

The coil spring 40 is installed above the guide 30. The coil spring 40 prevents an instrument from propagating an impact occurring when the inspection probe 15 collides with the nozzle 8 or other parts at the time of inspecting the nozzle 8.

The universal joint 50 is provided as two parts. The universal joints 50 are installed over the inspection probe 15 and reduce a rotary resistance caused by eccentricity when the inspection probe 15 is inserted into the nozzle 8 and performs a rotary scanning.

The inspection probe 15 is designed such that its center coincides with the ROSA-V six-axis system 6.

The bladder 60 is installed under the motor 10 and prevents the ROSA-V 6 from hanging down due to a self-weight of the end effector 70.

Thus, the bladder 60 can reduce weight as much as buoyancy in water.

The cross shape guide 80 is installed at lower end parts of the ball screw 20 and the end effector 70 and guides four-direction motion of the inspection probe 15.

An operation of the nozzle inspection apparatus installed at a bottom of the nuclear reactor 1 according to the present invention will be briefly described below.

A worker selects the nozzle 8 to inspect fine cracks of the nozzle 8 and the nuclear reactor and defects of the weld part of the nozzle 8.

The motor 10 is automatically driven to rotate the ROSA-V 6 toward the nozzle 8 selected for the inspection and position the inspection probe 15.

When the motor 10 is driven, the ball screw 20 interworking with the motor 10 vertically moves downward and moves the inspection probe 15 above the nozzle 8.

The inspection probe 15 is guided by the guide 30 and moving above the nozzle 8 and then inserting into the nozzle 8, and is arranged.

After the inspection probe 15 is inserted into the nozzle 8 and performs inspection, the motor 10 is again inversely rotated and the ball screw 20 moves vertically upward.

If the ball screw 20 moves vertically upward, the inspection probe 15 is restored to an original position and as a result, the inspection for the nozzle 8 is completed.

The inspection apparatus for the reactor BMI nozzle has an effect of, in the case of a long-time operating nuclear reactor, detecting and checking all defects of the weld part of the nuclear reactor and inspecting and checking a state of the nuclear reactor through inspection for the reactor BMI nozzle having not yet been inspected, thereby guaranteeing a general soundness of the nuclear reactor.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An inspection apparatus installed at a quick connector 7 of a Remotely Operated Service Arm-V (ROSA-V) six-axis system 6 and automatically inspecting a reactor Bottom Mounted Instrumentation (BMI) nozzle 8, the apparatus comprising:
a motor 10 installed at a transmission 11 of a bracket 9 provided under the quick connector 7 of the ROSA-V 6 six-axis system and enabling vertical driving of an inspection probe 15;
a ball screw 20 for vertically reciprocating the inspection probe 15 by converting a rotary motion of the motor 10 into a vertical motion;
a guide 30 for compelling an axial arrangement of the inspection probe 15 and removing eccentricity generated when the inspection probe 15 is inserted into the nozzle 8; and
a coil spring 40 installed above the guide 30 and preventing an impact propagation of an instrument.

2. The apparatus of claim 1, further comprising: two universal joints 50 installed over the inspection probe 15 and reducing a rotary resistance caused by eccentricity when the inspection probe 15 is inserted into the nozzle 8 and performs rotary scanning.

3. The apparatus of claim 1, further comprising: a bladder 60 installed under the motor 10 and preventing the ROSA-V 6 from hanging down due to a self-weight of an end effector 70.

4. The apparatus of claim 1, further comprising: a cross shape guide 80 installed at a lower end of the ball screw 20 and guiding four-direction motion of the inspection probe 15.
